(19) United States
(12) Patent Application Publication
(10) Pub. No.: US 2005/0267635 A1
(43) Pub. Date: Dec. 1, 2005

(54) Operation range restricting device for robot joint provided with operation region detection device

(75) Inventors: Takeshi Okada, Yamanashi (JP); Hiroshi Uchida, Maebashi-shi (JP); Masashi Ooe, Yamanashi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FANUC LTD., Yamanashi (JP)

(21) Appl. No.: 11/135,498

(22) Filed: May 24, 2005

(30) Foreign Application Priority Data
May 25, 2004 (JP) 2004-154574(PAT.)

(51) Int. Cl. G06F 19/00

(52) U.S. Cl. 700/245; 700/263

(57) ABSTRACT

An operation region detection device includes a dog, a support member for supporting it, and a detection switch outputting a signal based on contact or noncontact with the corresponding dog. The support member is arranged in a hollow part of a joint of a robot and attached to one of two link members of the robot rotatable relative to each other so that a center axis of the support member is substantially aligned with a rotation axis of relative rotation of the two link members. The dog is attached to the outer circumference of the support member and has a length corresponding to a predetermined detection region along a peripheral direction of the outer circumference. The detection switch is provided on the other of the two link members at a position facing the dog to detect a region to which a current position of the relative rotation belongs based on the state of output of the signal. An operation range restricting device for restricting an operation range of the relative rotation based on a region to which a current position of the detected relative rotation belongs.

### BACKGROUND OF THE INVENTION

1. Field of the Invention

The present invention relates to an operation region detection device for detecting a region to which a current position of relative rotation in a hollow structure joint for allowing relative rotation of two link members belongs and to an operation range restricting device for a robot joint using that device.

2. Description of the Related Art

As a safety measure for operators around an industrial robot (hereinafter referred to as simply a “robot”), a function of monitoring a position and/or posture of the robot and issuing an alarm and stopping the robot when the robot mistakenly enters the work space for operators or is about to enter it is generally used. Further, a similar function is used for the purpose of preventing interference with peripherals and other nearby robots even when operators are not working around the robot.

As devices for realizing such a function, it is known to provide a robot with an operation region detection device and an operation range restricting device utilizing the same. These devices (hereinafter referred to all together as “operation region detection and restricting devices”) are comprised of detection devices independent from the control system of the robot (system for conducting numerical control of servo motors for different axes). Therefore, even if for example there is an abnormality in the control system of the robot and the robot runs out of control, the robot makes an emergency stop so as to ensure safety. That is, when results of detection contrary to the conditions designated in advance by the user are obtained by the operation region detection and restricting devices, the robot enters an alarm state and is forcibly made to stop. As the operation region detection and restricting devices, ones of types using contact switches attached to joints comprised of two members rotating relative to each other are generally known. Further, as optional specifications, the devices are often attached by attaching contact switches to the outside circumference of the joint after assembling the robot.

FIGS. 1 and 2 show a joint of a robot provided with such a conventional operation region detection and restricting devices by a side view (FIG. 1) and a cross-sectional view taken along the line II-II of that side view. As illustrated in these figures, a link base 51 to which one link of the robot is attached and a link base 52 to which the other link of the robot is attached are connected through a speed reducer 53 and are driven to rotate relative to each other by the rotational output of a motor 54. The link base 51 has a switch table 55 attached to it, which in turn has a switch 56 and switch 57 attached to it. Further, the link base 52 has a dog table 58 attached to it, which in turn has a dog 59 and dog 60 attached to it. The position of attachment of the dog 59 is determined so that the dog 59 contacts a head of the switch 56 when the relative rotational position between the link base 51 and link base 52 reaches a predetermined first position, while the position of attachment of the dog 60 is determined so that the dog 60 contacts a head of the switch 57 when the relative rotational position between the link base 51 and link base 52 reaches a predetermined second position.

When the dog 59 contacts the head of the switch 56, a signal indicating the contact state is output from the switch 56 to the outside until the contact is lost. Similarly, when the dog 60 contacts the head of the switch 57, a signal indicating the contact state is output from the switch 57 to the outside until the contact is lost.

By providing one of the link bases 51 and 52 with one or more switches and providing the other with one or more dogs contacting and pressing against the switches, signals indicating that the relative rotational positions of the two links of the robot connected to each other have become at least one specific angle are output from the switches 56 and 57 and it becomes possible to determine what region (range) the link base 52 is positioned in with respect to the link base 51. Further, when it has been judged from the results of determination that the robot has entered a danger region, an alarm can be issued and the robot immediately made to stop so as to secure safety.

However, when using the conventional operation region detection and restricting devices explained above, the dogs of the devices become large since they are attached to the devices at the outside of the swivel part of the robot and accordingly the positions for attachment of the switches become further outside. Due to this, the range of interference of the robot becomes greater. As a result, after attachment of the operation region detection and restricting devices, it is not only necessary to confirm that the robot does not interfere with the surroundings, but also the problem arises that it is not possible to improve the density of arrangement of robots. In addition, the general practice is to change the designation of the operation range in accordance with the system, so the operation region detection and restricting devices are attached to the robot after the outlines of the system have been determined. Therefore, at this time, there are problems that the individual parts become larger and the work amount required for installation of each robot increases due to the attachment of the operation region detection and restricting devices. Further, the large size of the parts is disadvantageous in terms of cost as well. Reduction of size has therefore been desired.

### SUMMARY OF THE INVENTION

Therefore, the present invention has as its object the elimination of these problems in the prior art and the provision of operation region detection and restricting devices which is compact, does not invite an expansion of the range of interference with the surroundings, and enables an easy reduction of cost.

The present invention achieves the above object by utilizing the hollow part in a robot joint having a hollow structure to arrange the components of the operation region detection and restricting devices therein.

The present invention provides, in one aspect, an operation region detection device for detecting an operation region of relative rotation in a hollow structure joint for allowing relative rotation of two link members of a robot, which includes at least one dog, a support member for supporting the at least one dog, and at least one detection switch provided corresponding to the at least one dog and outputting a signal based on contact or noncontact with the corresponding dog, the support member being arranged in the hollow part of the joint and attached to one of the two link members so that a center axis of the support member is substantially aligned with a rotation axis of the relative rotation; the at least one dog being attached to the outer circumference of the support member and having a length corresponding to a predetermined detection region along a peripheral direction of the outer circumference; and the at least one detection switch being provided on the other of the two link members at a position facing the dog, to detect a region to which a current position of the relative rotation belongs based on the state of output of the signal.

The above operation region detection device may be comprised so that the at least one dog is a plurality of dogs and at least one detection switch is a number of detection switches corresponding to the number of the plurality of dogs. In this case, it is preferable that the plurality of dogs are aligned in a center axial direction of the support member and supported by the support member and that the detection switches are arranged corresponding to the plurality of dogs.

Further, the present invention provides, in a second aspect, an operation range restricting device for a robot joint which includes a restricting means for restricting an operation range of relative rotation in a hollow structure joint for allowing relative rotation of two link members of a robot, wherein the restricting means restricts an operation range of the relative rotation based on a region to which a current position of the relative rotation belongs detected by the operation region detection device as set forth above.

In the respective aspects of the present invention, the at least one dog may be attached directly to the support member or may be attached indirectly to it through an adapter.

According to the present invention, the components forming the operation region detection device and operation range restricting device can be made more compact and the installation steps can be reduced. Further, along with this, the costs can be easily reduced and the maintenance ability is also improved.

Further, according to the present invention, even if the operation region detection device and operation range restricting device are provided at a robot, they do not stick out from the robot, so do not cause an expansion of the range of interference with peripherals. As a result, it becomes possible to improve the density of arrangement of robots.

### BRIEF DESCRIPTION OF THE DRAWINGS

The above and other objects, features and advantages of the present invention will be described in more detail below based on the preferred embodiments of the present invention with reference to the accompanying drawings, wherein:

FIG. 1 is a side view of a joint of a robot provided with conventional operation region detection and restricting devices;

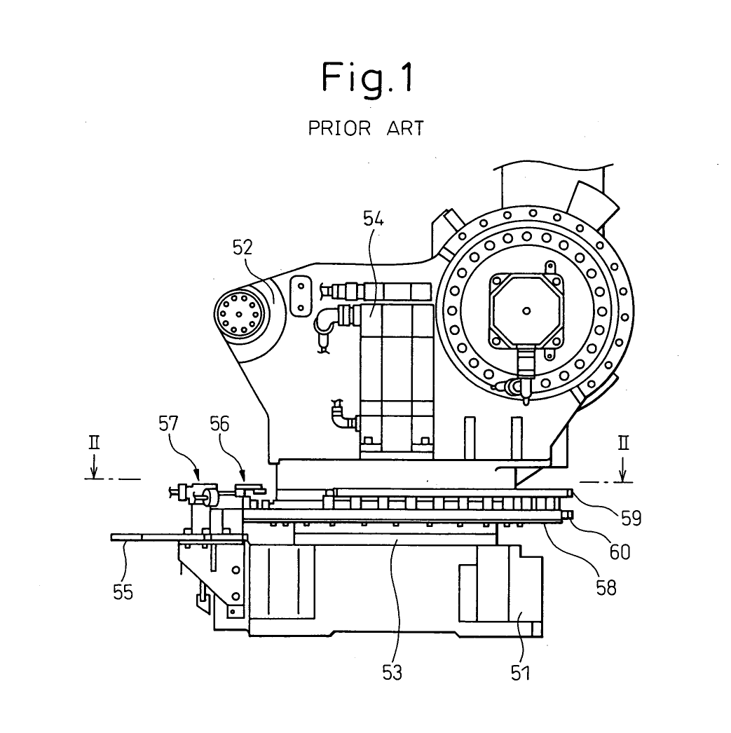

FIG. 2 is a cross-sectional view taken along line II-II of FIG. 1 showing the joint of the robot provided with the conventional operation region detection and restricting devices;

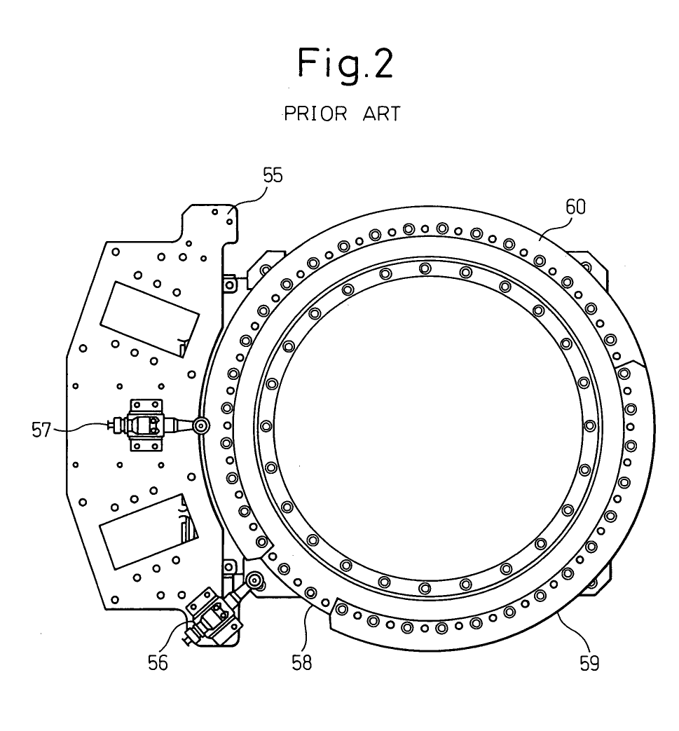

FIG. 3 is a cross-sectional view of a joint of a robot provided with operation region detection and restricting devices according to an embodiment of the present invention;

FIG. 4 is a partial enlarged view of a part of the joint shown in FIG. 3;

FIG. 5 is a perspective view of the part near dogs and switches of operation region detection and restricting devices according to an embodiment of the present invention; and

FIG. 6 is a block diagram showing the configuration for restricting the operation range of the robot joint based on the results of detection of the operation region.

### DETAILED DESCRIPTION

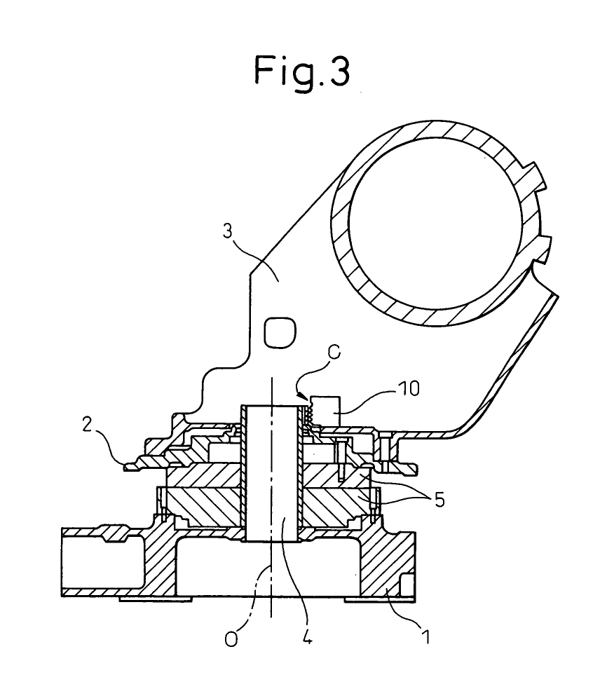

Embodiments of the present invention will be described below with reference to FIG. 3 to FIG. 6.

FIG. 3 is a cross-sectional view of a joint of a robot provided with operation region detection and restricting devices according to an embodiment of the present invention. In FIG. 3, reference numeral 1 indicates a first member corresponding to a J1 base (first link base) fixed to a housing of a speed reducer 5. Further, reference numeral 2 indicates a second member (table shaped member) which is fixed to an output shaft of the speed reducer 5 and connected to a third member 3 corresponding to a J2 base (second link base). On the other hand, an input shaft of the speed reducer 5 is connected to a not shown motor (for driving the J1 axis).

The speed reducer 5 constitutes a joint together with the second member 2 and has a well-known structure in which a hollow part extends along a rotation axis 0. Further, the second member (table shaped member) 2 also has an opening (extending along the rotation axis 0) at formed at a position corresponding to the hollow part of the second member 2. The rotation of the motor makes the second member 2 and the third member (J2 base) to rotate in an integrated manner about the rotation axis 0 relative to the first member (J1 base).

To provide such a joint with operation region detection and restricting devices, a pipe-shaped fourth member 4 is passed through the hollow part extending along the rotation axis 0. The fourth member 4 is a member for supporting the later-mentioned dogs. One end of the fourth member 4 is fixed to the first member 1 using bolts or other fastening means (not shown). Due to this, the fourth member 4 is arranged so that the axis of the pipe-shaped fourth member (axis of hollow part) is substantially aligned with the rotation axis 0. Further, a hole extends inside the fourth member 4 along the rotation axis 0.

Next, switches and corresponding dogs contacting or not contacting the switches depending on the relative rotational position between the first member 1 and the third member 3 will be described. As shown in FIG. 3, a switch unit 10 is arranged on the third member 3. Reference character C in FIG. 3 indicates a part where a switch (biasing element) attached to the switch unit 10 comes in contact with a dog provided at the outer circumference of the fourth member 4. The switch unit 10 naturally orbits around the rotation axis 0 when the third member 3 rotates relative to the first member 1. As a result, the dogs and switches (biasing elements) come into contact or lose contact according to the orbiting position of the switch unit 10.

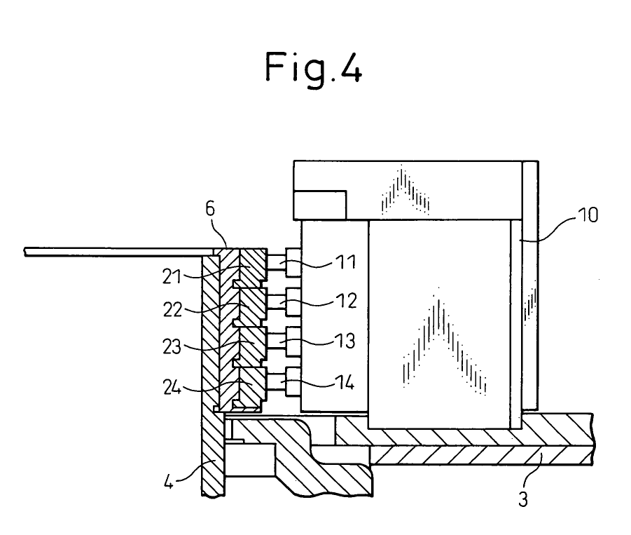

FIG. 4 is a partial enlarged view showing the part C enlarged. As shown in FIG. 4, a total of four dogs 21 to 24 in this example are attached to the outer circumference of the fourth member 4 through the fifth member (adapter) 6. Further, the switch unit 10 is provided with switches (biasing elements) 11 to 14 corresponding to the dogs 21 to 24. The switches 11 to 14 have the function of elastically displacing, for example by application of a pressing force, and switching an internal circuit from “off” indicating the noncontact state to “on” indicating the contact state. Note that such switches and internal circuit are known, so explanations will be omitted.

To enable adjustment of the positional relationships (in particular distance) between the switches 11 to 14 and corresponding dogs 21 to 24, the switch unit 10 is preferably placed on the third member 3 so that its horizontal position and height position relative to the third member 3 can be adjusted by a suitable position adjustment mechanism.

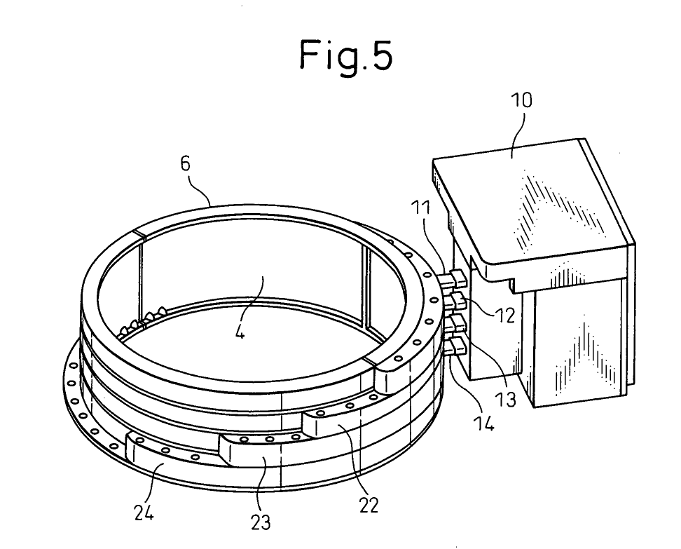

FIG. 5 shows by a perspective view the part related to the dogs 21 to 24 and switches (biasing elements) 11 to 14 of FIG. 4. As will be easily understood from FIG. 5, the dogs 21 to 24, which are provided in a plurality of rows and arranged in the direction of the rotation axis 0, have arc-shaped shapes and have lengths corresponding to the desired associated detection regions along the peripheral direction of the outer circumference of the fourth member 4. On the other hand, the switches (biasing elements) 11 to 14 are arranged at height positions so as to match with the rows of dogs 21 to 24 provided in the plurality of rows (fine adjustment of the height preferably possible). When the motor connected to the input shaft of the speed reducer 5 starts to rotate, the dogs 21 to 24 and the switches 11 to 14 start relative rotation.

Further, when for example the dog 21 and the switch 11 contact each other, the switch unit 10 senses this contact and outputs a signal expressing a “state where the dog 21 and the switch 11 contact each other” to the outside. Similar sensing of contact and output of a signal are performed for the dog 22 and the switch 12, the dog 23 and the switch 13, and the dog 24 and the switch 14. The angular range of contact of each dog with the corresponding switch (biasing element) can be adjusted by selecting the length of the dog (length along the peripheral direction of the outer circumference of the fourth member 4). Further, the boundary position (critical angle) of the contact/noncontact can be determined by selecting the mounting position of the dog along the peripheral direction of the outer circumference of the fourth member 4.

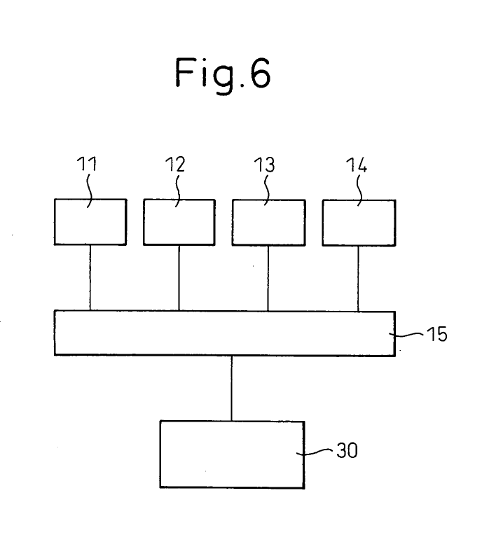

FIG. 6 is a block diagram showing a configuration for restricting the operation range of the robot based on the results of detection of the operation region. In FIG. 6, reference numeral 15 indicates a signal processing circuit for outputting a four-digit binary signal according to whether or not the switches 11 to 14 contact the corresponding dogs. Each digit of the binary signal for example indicates “contact” by “1” and “noncontact” by “0”. The signal processing circuit 15 is connected to the robot controller 30 for controlling the robot, and the robot controller 30 can recognize the angular range of the relative rotational position between the first member 1 and the third member 3 based on the four-digit binary signal sent from the signal processing circuit 15.

For example, if all of the switches (biasing elements) 11 to 14 are in contact with the corresponding dogs, “1111” is output from the signal processing circuit 15. Conversely, if all of the switches 11 to 14 are not in contact, “0000” is output from the signal processing circuit 15. Further, if only the switch (biasing element) 11 is not in contact and the other switches 12 to 14 are in contact, “0111” is output from the signal processing circuit 15, while if the switches (biasing elements) 11 and 12 are not in contact and the other switches 13 and 14 are in contact, “0011” is output from the signal processing circuit 15. Similarly, four-digit binary signals are sent to the robot controller 30 in one-to-one correspondence with all of the combinations of contact and noncontact able to be taken by the switches 11 to 14.

The memory of the robot controller 30 stores the correspondence between the four-digit binary signals and angular ranges of the relative rotational positions of the first member 1 relative to the third member 3 in the format of table data. The CPU of the robot controller 30 compares the four-digit binary signal sent from the switch unit 10 at predetermined short cycles with the table data, checks the angular range to which the current relative rotational position between the first member 1 and the third member 3 belong, and for example displays it on an attached display.

The relative rotational position between the first member 1 and the third member 3 can be restricted based on this result. For example, if the state where all of the switches 11 to 14 are in the noncontact state signifies the danger region, at the time of confirmation of the four-digit binary signal “0000”, an alarm can be output and the robot can be forcibly made to stop. Further, for example, if the binary signal “0001” (the state of contact with only switch 11) is used to signify that while the robot does not have to be stopped, it is in undesirable angular range, it is also possible to notify the operator of this by a buzzer, flashing display on a display, etc.

Note that the embodiments described above were configured with four pairs of dogs and switches, but this is only an example. That is, it is possible to provide a single pair or any plurality of pairs depending on the given conditions. Further, the dogs are attached to the fourth member (dog support member) 4 through the fifth member (adapter) 6 in the shown embodiment, but may also be attached directly to the fourth member 4.

While the present invention has been described above with reference to the specific embodiments shown in the accompanying drawings, these embodiments are only for explanatory and are not limitative. Therefore, the range of the present invention is limited only by the claims. The preferred embodiments of the present invention can be modified or changed in any way without departing from the scope of the claims.

1. An operation region detection device for detecting an operation region of relative rotation in a hollow structure joint for allowing relative rotation of two link members of a robot, said operation region detection device comprising at least one dog, a support member for supporting said at least one dog, and at least one detection switch provided corresponding to said at least one dog and outputting a signal based on contact or noncontact with the corresponding dog,
said support member arranged in the hollow part of said joint and attached to one of said two link members so that a center axis of said support member is substantially aligned with a rotation axis of said relative rotation;
said at least one dog attached to the outer circumference of said support member and having a length corresponding to a predetermined detection region along a peripheral direction of said outer circumference; and
said at least one detection switch provided on the other of said two link members at a position facing said dog, to detect a region to which a current position of said relative rotation belongs based on the state of output of said signal.

2. The operation region detection device according to claim 1, wherein said at least one dog comprises a plurality of dogs and said at least one detection switch comprises a number of detection switches corresponding to the number of said plurality of dogs.

3. The operation region detection device according to claim 2, wherein said plurality of dogs are aligned in a center axial direction of said support member and supported by said support member, and said detection switches are arranged corresponding to said plurality of dogs.

4. An operation range restricting device for a robot joint comprising a restricting means for restricting an operation range of relative rotation in a hollow structure joint for allowing relative rotation of two link members of a robot, wherein
said restricting means restricts an operation range of said relative rotation based on a region to which a current position of said relative rotation belongs detected by said operation region detection device according to claim 1.
